(19) United States
(12) Patent Application Publication
(10) Pub. No.: US 2016/0230298 A1
(43) Pub. Date: Aug. 11, 2016

(54) Electrochemical cell assembly and process of making and using same

(71) Applicant: Paul E. Cook, Ann Arbor, MI (US)

(72) Inventor: Paul E. Cook, Ann Arbor, MI (US)

(21) Appl. No.: 14/544,714

(22) Filed: Feb. 9, 2015

(51) Int. Cl. C25C 7/02; C25C 1/00; C02F 1/461

(52) U.S. Cl. CPC C25C 7/02; C02F 1/46109; C25C 1/00; C02F 2001/46161; C02F 2001/46133

(57) ABSTRACT

The invention comprises an assembly or apparatus for removing metal ions from an aqueous stream of metals by an electrolytic process. The apparatus comprises an electrochemical-cell assembly having at least one knit-mesh metal cathode porous to an aqueous stream of metal ions and at least one anode. The metal-mesh cathode may be of the same metal as one of the metals in the aqueous stream. By electrodeposition, at least one metal ion from the stream is precipitated onto the metal-mesh cathode in the cell assembly.

### RELATED APPLICATION

This patent application filed under 35 USC 111(a) claims the benefit of copending provisional application filed under 35 USC 111 (b) having application Ser. No. 61/941,806 filed on Feb. 19, 2014 entitled: Electrochemical Cell Assembly and process of making and using same.

### FIELD OF INVENTION

This invention relates to an electrochemical cell assembly and the process of making and using the assembly to recover metals from a waste water plating process. The invention particularly discloses a process of providing an electrochemical-cell assembly comprising at least one metal mesh cathode porous to a stream of metal ions at least one anode and a process for removing said metal ions from the aqueous stream.

### BACKGROUND OF THE INVENTION

U.S. Pat. No. 05,071,517 discloses a method of treating a substrate with an aqueous solution containing a dispersion of precious metals and tin. U.S. Pat. No. 5,342,501 discloses a method of treating a substrate with a tin-palladium catalyst and a promoter to improve the electro-conductivity. Further, U.S. patents disclose processes of pretreating prior to electroplating a non-conductive material with a palladium-tin solution; see U.S. Pat. Nos. 4,919,768 and 5,007,990.

The following relates to a process used to condition and activate plastic substrates for metal plating. A primary interest is the recovery of metal such as palladium-tin Activation (aka: Catalyst) from the rinse water following Activation in a metal plating process. At the present time there is no commercialized method for recovery of the metal precipitates that form in the Activation process and from the rinse water following Activation. There are normally two rinses after the Activation. They are counter flowing or concurrent rinses flowing at 2-4 gallons per minute. The process removes the precipitated metal such as palladium/tin using a filtration device and deposits the metal in a tank separated from the process line. At that point the precipitate is acidified to re-solubilize the metal and allow electrolytic recovery of the metal on a high-surface area geometric-shaped cathode characterized as a knit mesh of metal having a number of openings per unit of area in a sieve.

### SUMMARY OF THE INVENTION

A variation of this invention includes a process comprising recovering metal from a stream of metal ions derived from electroplating and using the recovered metal in subsequent processes. The process comprises an aqueous stream containing metal ions and an electrochemical-cell assembly containing a stream inlet, at least one metal-mesh cathode porous to the stream, at least one anode, and a stream outlet wherein said cathode may be of the same metal of at least one of the metal ions in the stream; passing the stream through the inlet of the electrochemical cell assembly; passing the stream through the pores of the cathode; passing an electrical current through the anode and the cathode of the electrochemical cell assembly, thereby depositing at least one of the metal ions in the stream onto said cathode and reducing the amount of metal ions in the stream to produce a depleted stream; passing the depleted stream to the outlet of the electrochemical cell assembly; and using the deposited metal ions on the cathode to provide a source of the metal.

A variation of this invention includes a product comprising an electrochemical cell assembly containing a cathode of a knit metal mesh. The cathode can be characterized as a metal screen, woven metal or metal wool and the like and further comprising a stream of metal wherein the metal of the cathode mesh is the same as at least one of the metal ion in the stream. Other illustrative variations of the invention will become apparent from the detailed description provided hereinafter. It should be understood that the detailed description and specific examples, while disclosing optional variations of the invention, are intended for purposes of illustration and are not intended to limit the scope of the invention.

### DESCRIPTION OF THE DRAWINGS

Select examples of the invention will become more fully understood from the detailed description and the accompanying drawings, wherein:

FIG. 1 is an illustration of an assembly or product and process according to a number of variations of the invention.

FIG. 2 is another illustration of the assembly or a product and process according to a number of variations.

### DETAILED DESCRIPTION OF THE INVENTION

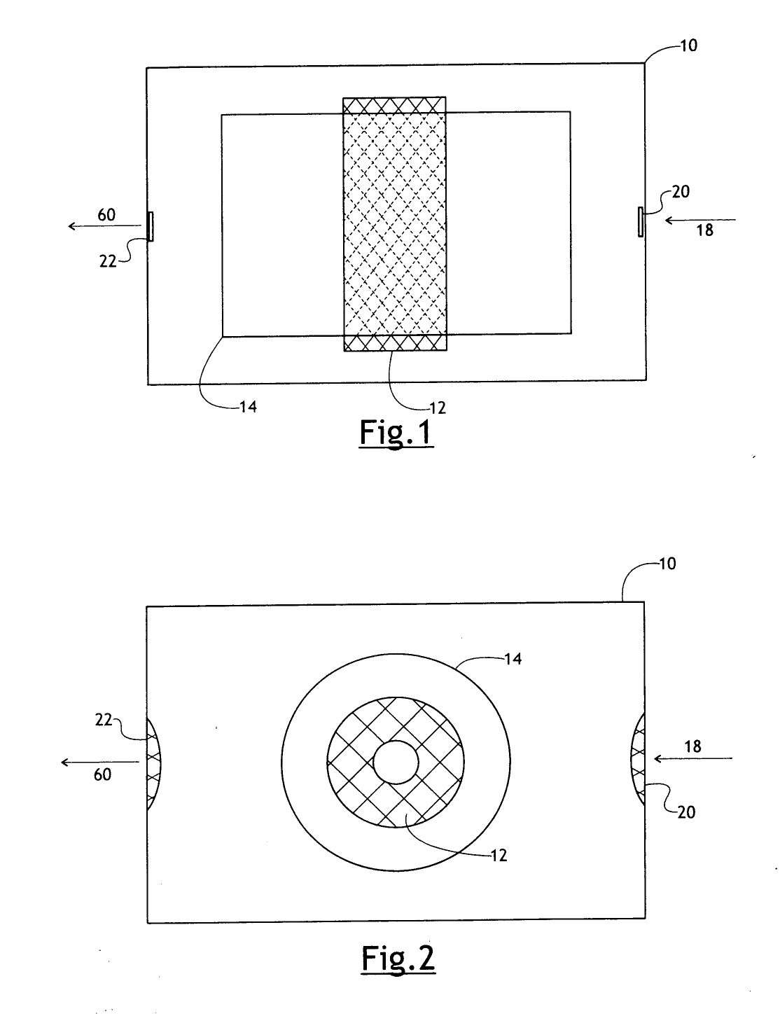

An assembly or apparatus according to a number of variations as shown in FIG. 1. The apparatus comprises an electrochemical cell assembly 10. The electrochemical cell assembly 10 comprises at least one cylindrical mesh cathode 12 and an anode 14. A stream 18 enters the electrochemical cell assembly 10 through an inlet 20 and exits the electrochemical cell assembly 10 through an outlet 22. The aqueous stream 18 comprises ions selected from the group consisting of ions of zinc, nickel, copper, tin, iron silver, gold, palladium, platinum, chromium, precious metal ions, and mixtures thereof. The aqueous stream 18 may have a metal ion content in a range from 0.5 to 500 grams per liter. The assembly may be constructed and arranged for collection of metal from a stream of metal ions onto the cathode for use in subsequent processes.

The cathode 12 comprises a porous knit mesh. The knit mesh consist of at least one design selected from the group consisting of a metal mesh, a metal screen, a woven material, a knit metal and metal wool. The cathode 12 consist at least one metal selected from the group consisting of zinc, nickel, copper, tin, iron, silver, gold, palladium, platinum, chromium, cobalt, cadmium, precious metal ions and various mixtures or alloys thereof. Preferably, the cathode 12 is made of a metal selected from the group consisting of steel, copper, nickel and alloys thereof. The preferred shape of the cathode is oval or cylindrical. The cathode 12 may be of the same metal of at least one of the metal ions in the stream of metals 18. The knit mesh cathode may be a honeycomb structure or may be a repeating pattern. The knit mesh cathode may have a repeating shape, including, but not limited to shapes selected from the group consisting of squares, triangles, rectangles, circles, ovals, trapezium, rhombuses, or other polygons including, but not limited to, hexagon, pentagon, heptagon, octagon, nonagon or decagon. The cathode 12 may be a hollow 3-dimensional shape selected from the group consisting of a cylinder, cone, cube, cuboid, prism, pyramid, or a frustum. The cathode 12 may be folded over or may have multiple layers. The cathode may be a high-surface porous metallic mesh cathode. The cathode may be made of powdered metal that may be sintered. The cathode 12 may optionally be protected by cathode circuit breakers and have a porosity of 5 to 100 pores per inch (ppi) or about 5 to 25 ppi. A pore means one having an aperture of 3.0-0.2 mm in diameter, when compared to the range of ppi (5-100 ppi) in a number of variations. The electrochemical cell apparatus or assembly 10 may comprise a plurality of knit mesh cathodes 12.

The anode 14 may be a DSA (dimensionally stable anode). The anode 14 may be inert and porous. The anode 14 may comprise a metal made of a knit mesh. The knit mesh consists of a metal mesh, a metal screen, a woven metal, a knit metal or metal wool. The metal may be at least one metal selected from the group consisting of titanium, palladium, or platinum. The anode 14 may contain a rare earth metal coating, such as a coating selected from the group of metals consisting of scandium, yttrium, lanthanum, cerium, praseodymium, neodymium, promethium, samarium, europium, gadolinium, terbium, dysprosium, holmium, erbium, thulium, ytterbium or lutetium. The electrochemical cell assembly or apparatus 10 may comprise a plurality of anodes 14 which may be oriented in any fashion within the electrochemical cell assembly 10.

The electrochemical cell assembly 10 may include other optional components. A separator may separate the anode 14 from the cathode 12. The separator comprises a spacer of molded plastic. The separator may be a permeable diaphragm, cationic or anionic membrane. The separator may be placed on the anode 12 to avoid short-circuiting between the anode 14 and the cathode 12 while maintaining uniform distribution of current over the entire surface of the electrochemical cell assembly 10. The electrochemical cell assembly 10 may comprise a plurality of separators.

The electrochemical cell assembly 10 may include a cell body. The cell body may comprise a plastic such as a polymeric plastic selected from the group consisting of polypropylene, polyethylene, polyvinyl chloride, polycarbonate or poly(meth)acrylic. The cell body contains a series of grooves to fix the cathode 12 or the anode 14 or both in position within the electrochemical cell assembly 10.

The electrochemical cell 10 includes at least one current collector. The current collector comprises a metal including, but not limited to, copper. The electrochemical assembly 10 may include a flow distributor. The flow distributor comprises a polymer such as, but not limited to, polypropylene, polyethylene, polyvinyl chloride, polycarbonate or poly(meth)acrylic. The flow distributor may allow for dispersion of the stream 18 in uniform flow throughout the electrochemical cell assembly 10. In a number of variations, flow distributors may be placed at the inlet 20, and the outlet 22 of the electrochemical cell assembly 10.

The electrochemical cell assembly 10 may include a cover to prevent foreign objects from entering the electrochemical cell assembly 10 while allowing for gaseous products to freely escape. The electrochemical assembly 10 may include cathode circuit breakers. The cathode circuit breakers protect electrical overload by a 20 ampere circuit breaker. The electrochemical assembly 10 may include an air sparger. The air sparger comprises a perforated double tub located at the bottom of the electrochemical assembly 10. The air sparger provides air bubbles to improve stream 18 agitation and dilution of the gases produced at the anode 14 and the cathode 12. The electrochemical assembly 10 may include a pump for pumping the steam 18 through the electrochemical cell assembly 10. The pump may have a magnetic drive up to 10 gal/min. The electrochemical assembly 10 may include an educator. The educator comprises a series of high solution flow educators connected to a pump that can be utilized for increased flow rates. The electrochemical cell assemble 10 may include a rectifier. The rectifier may be 100, 300, 500, 750, or 1000 A (amperes) and 8-10 volts depending on the size of the electrochemical cell assembly 10.

The electrochemical cell assembly 10 may include a liquid level control. The liquid level control device detects low stream 18 levels and turns off the rectifier if this should occur. The liquid level control may be connected to a heat sensor control that may be connected to the rectifier to insure that the temperature of the stream 18 in the cell assembly may be within the desired temperature, such as less than 140° F. (60° C.). The electrochemical cell assembly may include a flowmeter. The flowmeter may allow 0-10 gal/min of stream 18 through the electrochemical cell assembly 10. The electrochemical cell assembly 10 may include a filter. The filter may be a polypropylene and carbon cartridge type filter utilized for removing solids and organic matter prior to entering the electrochemical cell assembly 10.

For example, the process comprises recovering metal from the stream of metal ions and using the recovered metal. Specifically, the process provides an aqueous stream 18 comprising nickel ions and includes an electrochemical cell assembly 10 having an aqueous stream inlet 20, at least one cathode 12 porous to the stream 18, at least one anode 14, and a stream outlet 22 wherein the cathode may be of the same metal as the metal ions in the stream 18. The process comprises passing the stream of nickel ions through the inlet 20 of the electrochemical cell assembly 10 and through the pores of the cathode 12 while passing an electrical current through the anode 14 and the cathode 12 of the electrochemical assembly 10, thereby depositing nickel ions in the stream 18 onto the cathode 12 and reducing the amount of metal ions in the stream 18 to produce a depleted stream 60. Preferably, the cathode is selected from the group consisting of a metal mesh of steel, copper, nickel and alloys thereof. The nickel bath may contain nickel sulfate, nickel chloride, boric acid, sulfuric and/or HCL to adjust the pH in the range of pH 3-5.0. The process captures the drag-out of solution that remains trapped on the plated articles and are rinsed in a stagnant (not flowing) rinse tank. This rinse tank will build in nickel ion concentration and is fed to the separated cell. The DSA anode (positive current) is separated from the catholyte in a porous ceramic diagram which contains H₂SO₄ at a concentration of 1-10% by volume, but preferably 5%. The cathode (negative current) could be steel, copper or nickel and is in the catholyte containing the nickel ions. As the deposition of nickel metal takes place the pH in the catholyte is continuously dropping and will produce poor deposits if the pH is not maintained with an appropriate alkali material such as sodium carbonate, potassium hydroxide or sodium hydroxide. The latter two are the most advantageous to use in a liquid form at a concentration of 2-10% active hydroxide. An automatic pH controller with a pump utilized to maintain the desired pH range. The DC current is supplied in the range of 2-30 amperes per square foot based on the cathode area and the ionic strength of the nickel solution. Metal can be recovered from high concentration (16 ounces per gallon of Nickel metal to <100 ppm solutions). The DC current has to be adjusted so as to not exceed the limiting current density of the electrolyte.

The process may be a batch process, a drag-out process, or a closed-loop process. The process may be continuous. The process can recover from 0.1-100% of the metal ions from the stream 18. The depleted stream 60 may be recycled back into the stream 18 for another pass through the electrochemical assembly 10. The cathode 12 may be removed from the electrochemical assembly 10 for use of the metal ions on the cathode 12. The metal ions of the stream 18 may be removed from the cathode 12 as a source of metal ions in subsequent processes.

Variation 1 comprises an electrochemical cell assembly having an aqueous metal stream inlet, at least one cathode porous to the stream, at least one anode, and an exit for the electrochemical cell assembly wherein the cathode contains at least one of the same metal ions as in the stream; passing the stream through the pores of the cathode; passing an electrical current through the anode and the cathode of the electrochemical assembly, thereby depositing at least one of the metal ions in the stream onto the cathode and reducing the amount of metal ions in the stream to produce a depleted stream; passing the depleted stream to the outlet of the electrochemical cell assembly' and using the deposited metal ions on the cathode to provide a source of the metal in subsequent processes.

Variation 2 includes a process as set forth in Variation 1 wherein the metal ions comprise at least one metal selected from the group consisting of zinc, nickel, copper, tin, iron, silver, gold, palladium, platinum, chromium, cobalt, cadmium, precious metal ions, and mixtures thereof. Variation 3 includes a process as set forth in Variations 1-2 wherein the cathode comprises a knit mesh of a metal.

Variation 4 includes a process as set forth in Variation 3 wherein the knit mesh contains at least one metal selected from the group consisting of zinc, nickel, copper, tin, iron, silver, gold, palladium, platinum, chromium, cobalt, cadmium, precious metal ions and mixtures thereof. Variation 5 includes a process as set forth in Variations 3-4 wherein the knit mesh is a honeycomb structure. Variation 6 includes a process as set forth in variations 1-5 wherein the cathode is a hollow 3-dimensional shape comprising at least one of a cylinder, cone, cube, cuboid, prism, pyramid, or a frustum. Variation 7 includes a process as set forth in Variation 1-6 wherein the cathode has multiple layers or is folded over. Variation 8 includes a process as set forth in Variations 3-7 wherein the knit mesh consist of a metal mesh, a metal screen, a woven metal, a knit metal, or metal wool. Variation 9 includes a process as set forth in Variations 1-8 wherein the electrochemical cell assembly has a plurality of alternating anodes and cathodes. Variation 10 includes a process as set forth in Variations 1-9 wherein the depleted stream is recycled back into the electrochemical cell assembly. Variation 11 includes an assembly including an electrochemical cell comprising a cathode, characterized as a knit mesh, metal screen, woven metal, knit metal, or metal wool, and a stream, wherein the metal in the cathode is the same as at least one metal ion in the metal stream.

Variation 12 includes an assembly as set forth in Variation 11 wherein the knit mesh comprises a metal selected from the group consisting of zinc, nickel, copper, tin, iron, silver, gold, palladium, platinum, cobalt, cadmium, precious metal ions and mixtures thereof. Variation 13 includes an assembly as set forth in Variations 11-12 wherein the stream comprises a metal selected from the group consisting of zinc, nickel, copper, tin, iron, silver, gold, palladium, platinum, chromium, cobalt, cadmium, precious metal ions, and mixtures thereof. Variation 13 includes an assembly as set forth in Variations 11-12 wherein the stream contains a metal selected from the group consisting of zinc, nickel, copper, tin, iron, silver, gold, palladium, platinum, chromium, cobalt, cadmium, selenium, precious metal ions, and mixtures thereof. Variation 14 includes an assembly as set forth in Variations 11-13 wherein the knit mesh comprises a honeycomb structure. Variation 15 includes an assembly as set forth in Variations 11-14 wherein the electrochemical cell assembly comprises an anode. Variation 16 includes an assembly as set forth in Variations 11-15 wherein the electrochemical cell assembly comprises a separator located between the anode and the cathode. Variation 17 includes an assembly as set forth in Variations 11-16 wherein the cathode is a hollow 3-dimensional shape such as a cylinder, cone, cube, cuboid, prism, pyramid, or a frustum. Variation 18 includes an assembly as set forth in Variations 11-17 wherein cathode has multiple layers or is folded over. Variation 19 includes an assembly as set forth in Variations 11-18 wherein the cathode is porous to the stream.

Variation 20 may include a product as set forth in any of Variations 11-19 wherein the cathode collects at least one of the metal ions of the stream when an electrical current is passed through the cathode. Variation 21 may include a product as set forth in any of Variations 11-20 wherein the stream has a metal ion content of 0.5 to 500 grams per liter. Variation 22 includes a product as set forth in any of Variations 11-21 wherein the knit mesh comprises a repeating pattern. Variation 23 may include a product as set forth in any of Variations 11-22 wherein the knit mesh has a repeating shape such as squares, triangles, rectangles, circles, ovals, trapezium, rhombuses, or other polygons. Variation 24 includes a product as set forth in any of Variations 11-23 wherein the knit mesh contains a powdered metal that is sintered. Variation 25 includes a product as set forth in any of Variations 11-24 wherein the electrochemical cell assembly contains at least one cathode circuit breaker. Variation 26 includes a product as set forth in any of Variations 11-25 wherein the cathode has a porosity of 5 to 100 pores per inch. Variation 27 includes a product as set forth in any of Variations 11-26 wherein the cathode has a porosity of 5 to 25 pores per inch. Variation 28 includes a product as set forth in any of Variations 11-27 wherein the anode has a dimensionally stable anode. Variation 29 includes a product as set forth in any of Variations 11-28 wherein the anode is inert.

Variation 30 includes a product as set forth in any of Variations 11-29 wherein the anode comprises a knit mesh. Variation 31 includes a product as set forth in any of Variations 11-30 wherein the anode consist of a knit mesh consisting of a metal mesh, a metal screen, a woven metal, a knit metal, or metal wool. Variation 32 may include a product as set forth in any of Variations 11-31 wherein the anode is porous. Variation 33 includes a product as set forth in any of Variations 11-32 wherein the anode consist of a metal consisting of at least one of a metal selected from the group of titanium, palladium, selenium and platinum. Variation 34 includes a product as set forth in any of Variations 11-33 wherein the anode consist of a rare earth metal coating consisting of scandium, yttrium, lanthanum, cerium, praseodymium, neodymium, promethium, samarium, europium, gadolinium, terbium, dysprosium, holmium, erbium, thulium, ytterbium, or lutetium. Variation 35 may include a product as set forth in any of Variations 11-34 wherein the electrochemical cell assembly consist of a plurality of anodes. Variation 36 includes a product as set forth in any of Variations 11-35 wherein the electrochemical cell assembly further comprises a separator containing at least one permeable diaphragm, a semipermeable diaphragm, a cationic membrane, or an anionic membrane. Variation 37 may include a product as set forth in Variation 36 wherein the separator is placed on the anode. Variation 38 includes a product as set forth in any of Variations 11-37 wherein the electrochemical cell assembly comprises a plurality of separations.

Variation 39 may include a product as set forth in any of Variations 11-38 wherein the electrochemical cell assembly contains a cell body comprising at least one of polypropylene, polyethylene, polyvinyl chloride, polycarbonate, or poly(meth)acrylic.

Variation 40 may include a product as set forth in Variation 39 wherein the cell body comprises a series of grooves to fix at least one of the cathode or the anode in position within the electrochemical cell assembly. Variation 41 includes a product as set forth in any of Variations 11-40 wherein electrochemical cell assembly contains at least one current collector containing a metal. Variation 42 may include a product as set forth in any of Variations 11-41 wherein the electrochemical cell assembly contains a flow distributor comprising a plastic consisting as least one of polypropylene, polyethylene, polyvinyl chloride, polycarbonate and poly(meth)acrylic. Variation 43 may include a product as set forth in any of Variations 11-42 wherein the electrochemical cell assembly further comprises an air sparger. Variation 44 includes a product as set forth in any of Variations 11-43 wherein the electrochemical cell assembly further comprises a pump. Variation 45 may include a product as set forth in any of Variations 11-44 wherein the electrochemical cell assembly further comprises an eductor. Variation 46 may include a product as set forth in Variation 45 wherein the eductor has an amperage of at least one of 100,300, 500, 750, or 1000 A. Variation 47 may include a product as set forth in any of Variations 11-46 wherein the electrochemical cell assembly further comprises a liquid level control. Variation 48 may include a product as set forth in any of Variations 11-47 wherein the electrochemical cell assembly further comprises a heat level control. Variation 49 may include a product as set forth in any of Variations 11-48 wherein the electrochemical cell assembly further comprises a flowmeter.

Variation 50 may include a product as set forth in any of Variations 11-49 wherein the electrochemical cell assembly further comprises a filter comprising a polypropylene or carbon cartridge filter. Variation 51 may include a product as set forth in any of Variations 11-50 wherein the electrochemical cell assembly further comprises a cover. Variation 52 may include a process as set forth in any of Variations 1-10 wherein the stream has a metal ion content of 0.5 to 500 grams per liter. Variation 53 may include a process as set forth in any of variations 1-10 and 52 wherein the knit mesh comprises a repeating pattern. Variation 54 may include a process as set forth in any of Variations 1-10 and 53-53 wherein the knit mesh comprising a repeating shape including squares, triangles, rectangles, circles, ovals, trapezium, rhombuses or polygons. Variation 55 may include a process as set forth in any of Variations 1-10 and 52-54 wherein the knit mesh comprises a powdered metal that is sintered. Variation 56 may include a process as set forth in any of Variations 1-10 and 52-55 wherein the electrochemical cell assembly further comprises at least one cathode circuit breaker. Variation 57 may include a process as set forth in any of Variations 1-10 and 52-56 wherein the cathode has a porosity of 5 to 100 pores per inch. Variations 58 may include a process as set forth in any of Variations 1-10 and 52-57 wherein the cathode has a porosity of 5 to 25 pores per inch. Variation 59 may include a process as set forth in any of Variations 1-10 and 52-58 wherein anode comprises a dimensionally stable anode. Variation 60 may include a process as set forth in any of Variations 1-10 and 52-59 wherein the anode is inert. Variation 61 may include a process as set forth in any of Variations 1-10 and 52-60 wherein the anode comprises a knit mesh. Variation 62 may include a process as set forth in any of Variations 1-10 and 52-61 wherein anode comprises a knit mesh comprising a metal mesh, a metal screen, a woven metal, a knit metal, or metal wool. Variation 63 may include a process as set forth in any of Variations 1-10 and 52-62 wherein the anode is porous. Variation 64 may include a process as set forth in any of Variations 1-10 and 52-63 wherein the anode comprises a metal comprising at least one of a titanium, palladium, selenium, or platinum. Variation 65 may include a process as set forth in any of Variations 1-10 and 52-64 wherein the anode comprises a rare earth metal coating including scandium, yttrium, lanthanum, cerium, praseodymium, neodymium, promethium, samarium, europium, gadolinium, terbium, dysprosium, holmium, erbium, thulium, ytterbium, or lutetium. Variation 66 may include a process as set forth in any of Variations 1-10 and 52-65 wherein the electrochemical cell assembly comprises a plurality of anodes.

Variation 67 may include a process as set forth in any of Variations 1-10 and 52-66 wherein the electrochemical cell assembly further comprises a separator consisting of at least one of permeable diaphragm, a semipermeable diaphragm, a cationic membrane, or an anionic membrane. Variation 68 may include a process as set forth in Variation 67 wherein the separator is placed on the anode. Variation 69 may include a process as set forth in any of Variations 1-10 and 52-68 wherein the electrochemical cell assembly contains a plurality of separators.

Variation 70 may include a process as set forth in any of Variations 1-10 and 52-69 wherein the electrochemical cell assembly comprises a cell body comprising at least one of polypropylene, polyethylene, polyvinyl chloride, polycarbonate, or poly(meth)acrylic. Variation 71 may include a process as set forth in Variation 70 wherein the cell body comprises a series of grooves to fix at least one of the cathode or the anode in position within the electrochemical cell assembly. Variation 72 may include a process as set forth in any of Variations 1-10 and 52-71 wherein electrochemical cell assembly comprises at least one current collector comprising a metal. Variation 73 may include a process as set forth in any of Variations 1-10 and 52-72 wherein the electrochemical cell assembly comprises a flow distributor consisting of a plastic such as polypropylene, polyethylene, polyvinyl chloride, polycarbonate, poly(meth)acrylic. Variation 74 may include a process as set forth in any of Variations 1-10 and 52-73 wherein the electrochemical cell assembly further comprises an air sparger. Variation 75 may include a process as set forth in any of Variations 1-10 and 52-74 wherein the electrochemical cell assembly further comprises a pump. Variation 76 may include a process as set forth in any of Variations 1-10 and 52-75 wherein the electrochemical cell assembly further comprises an eductor. Variation 77 may include a process as set forth in Variation 76 wherein the eductor has an amperage of at least one of 100, 300, 500, 750, or 1000 A. Variation 78 may include a process as set forth in any of Variations 1-10 and 52-77 wherein the electrochemical cell assembly further comprises a liquid level control. Variation 79 may include a process as set forth in any of Variations 1-10 and 52-78 wherein the electrochemical cell assembly further comprises a heat level control.

Variation 80 may include a process as set forth in any of Variations 1-10 and 52-79 wherein the electrochemical cell assembly further comprises a flowmeter. Variation 81 may include a process as set forth in any of Variations 1-10 and 52-80 wherein the electrochemical cell assembly further comprises a filter comprising a polypropylene or carbon cartridge filter. Variation 82 may include a process as set forth in any of Variations 1-10 and 52-81 wherein the electrochemical cell assembly further comprises a cover. Variation 83 may include a process as set forth in any of Variations 1-10 and 52-82 wherein the process is one of a batch process, a drag out process, or a closed loop process. Variation 84 may include a process as set forth in any of Variations 1-10 and 52-83 wherein the process is continuous. Variation 85 may include a process as set forth in any of Variations 1-10 and 52-84 wherein the process recovers from 0.1-100% of the metal ions in the stream 18. Variation 86 includes a process as set forth in any of Variations 1-10 and 52-85 further comprising recycling the depleted stream back into the stream. Variation 87 may include a process as set forth in any of Variations 1-10 and 52-86 further comprising removing the cathode from the electrochemical cell assembly. Variation 88 may include a process as set forth in any of Variations 1-10 and 52-87 further comprising removing the metal ions from the cathode.

The above description of various examples of the invention is exemplary and, thus, the variations or variants thereof are not to be regarded as a departure from the spirit and scope of the invention.

The invention claimed is:

1. A process for recovering metal from a waste water plating stream which comprises providing an electrochemical cell assembly containing a stream inlet, at least one metal-mesh cathode porous to a stream of metal ions, at least one anode, and a stream outlet, passing the stream of metal ions through the pores of said cathode, passing an electrical current through the anode and said cathode of the electrochemical cell assembly, thereby depositing at least one of the metal ions in the stream onto said cathode and reducing the amount of metal ions in the stream to produce a depleted stream of metal ions and passing the depleted stream to the outlet of the electrochemical cell assembly.

2. The process of claim 1 wherein the cathode is a knit mesh of metal selected from the group consisting of steel mesh, copper mesh, nickel mesh and alloys of said metal meshes.

3. The process of claim 2 wherein the knit mesh of the cathode has a honeycomb structure.

4. The process of claim 1 wherein the shape of the cathode is selected from the group consisting of a cylinder, cone, cube, cuboid, prism, pyramid and a frustum.

5. The process of claim 1 wherein the cathode has multiple layers.

6. The process of claim 2 wherein the cathode is a knit mesh of metal selected from the group consisting of a metal screen, a woven metal and metal wool.

7. The process of claim 1 wherein the electrochemical cell assembly has a plurality of alternating anodes and cathodes.

8. The process of claim 1 wherein the depleted stream of metal is recycled back into the electrochemical cell assembly.

9. The assembly of claim 2 wherein the porous metal-mesh cathode is the same as at least one metal ion in the stream, said metal is selected from the group consisting of zinc, nickel, copper, tin, iron, palladium, platinum, chromium, cobalt, cadmium and alloys thereof.

10. The assembly of claim 2 wherein the porous metal cathode is woven metal wool.

11. The assembly of claim 1 wherein the metal-mesh cathode is made of at least one metal selected from the group consisting of zinc, nickel, copper, tin, iron, palladium, platinum, chromium, cobalt and cadmium.

12. The assembly of claim 2 wherein the aqueous stream contains at least one metal selected from the group consisting of zinc, nickel, copper, tin, iron, silver, gold, palladium, platinum, chromium, cobalt, cadmium and selenium.

13. The assembly of claim 2 wherein the metal-mesh cathode has a honeycomb structure.

14. The assembly of claim 11 wherein the electrochemical cell assembly comprises a separator located between the anode and the cathode.

15. The assembly of claim 11 wherein the cathode has a hollow 3-dimensional shape.

16. The assembly of claim 2 wherein the cathode has multiple layers.

17. A process for recovering metal from an aqueous stream of metal ions having a pH of 3-5.0 which comprises providing an electrochemical-cell assembly containing a stream inlet, at least one metal mesh cathode porous to said stream of metal ions, at least one anode, and a stream outlet, passing the stream of metal ions through the pores of said cathode, passing an electrical current through the anode and the cathode of the electrochemical-cell assembly, thereby depositing at least one of the metal ions in the stream onto said cathode and reducing the amount of metal ions in the stream to produce a depleted stream of metal ions and passing the depleted stream to the outlet of the electrochemical-cell assembly.

18. The process of claim 17 wherein the metal ions in the aqueous stream is from the group consisting of zinc, nickel, copper, tin, iron, silver, gold, palladium, platinum, chromium, cobalt, cadmium and selenium.

19. The process of claim 17 wherein the cathode is a knit-mesh of a metal selected from the group consisting of steel, copper and nickel and alloys thereof.

20. The process of claim 19 wherein the knit-mesh cathode is cylindrical.
